(19) United States
(12) Patent Application Publication
(10) Pub. No.: US 2014/0365528 A1
(43) Pub. Date: Dec. 11, 2014

(54) ONLINE DATING DANGER PREVENTION SYSTEM

(71) Applicant: MARCELLIN SIMARD, SANTA FE, NM (US)

(72) Inventor: MARCELLIN SIMARD, SANTA FE, NM (US)

(21) Appl. No.: 14/302,129

(22) Filed: Jun. 11, 2014

Related U.S. Application Data
(60) Provisional application No. 61/833,715, filed on Jun. 11, 2013.

(51) Int. Cl. G06F 21/32

(52) U.S. Cl. CPC G06F 21/32
USPC 707/788

(57) ABSTRACT

An online dating danger prevention system is disclosed. The online dating danger prevention system includes a database that holds information, including geo-location data and photographs, to make online dating safer. An online dater enters a set of contacts that the system can reach in the event of an emergency.

### CLAIM OF BENEFIT TO PRIOR APPLICATION

This application claims benefit to U.S. Provisional Patent Application 61/833,715, entitled “A Database that holds information including geolocation and photographs to make online dating safer,” filed Jun. 11, 2013. The U.S. Provisional Patent Application 61/833,715 is incorporated herein by reference.

### BACKGROUND

Embodiments of the invention described in this specification relate generally to dating systems, and more particularly, to danger prevention in online dating.

Online dating is common in the dating world these days. Instead of meeting at live locations and venues, such as dances, card playing groups, bars, activities, etc., single people now have many options online to pursue dating opportunities. One appealing aspect of online dating is that a person can find out some information about another person prior to actually meeting the person for a date. However, there are new dangers in the dating world that arise out of such capabilities. In particular, the online world is a larger anonymous landscape that is ripe for lies and fraud in the form of simply boasting and exaggeration to more serious offenses, such as providing false personal information or even sometimes providing a false identity. This makes live meetings with a person met online a dangerous prospect, since faith is put into the honesty and truthfulness of a person one has never actually met in the past, and whom no one else in the person's circle of friends and family would even know.

Therefore, what is needed is a way to reduce or prevent dating dangers that one may encounter by discouraging any ill intentions when it comes to meeting someone for the first time or even subsequent times.

### BRIEF DESCRIPTION

Some embodiments of the invention include a novel online dating danger prevention system that validates each online dater's profile in order to create a safe dating environment for online daters. In some embodiments, the online dating danger prevention system performs a set of processes for preventing or reducing danger for online daters.

The online dating danger prevention system of some embodiments validates each online dater's profile by collecting data associated with the online dater. In some embodiments, the data associated with each online dater includes one or more of personal information, image data, location data, and document-based data. In some embodiments, the online dating danger prevention system stores the collected data in a database that is accessed from a computing device. In some embodiments, the online dating danger prevention system uses the collected and stored data to create safe dating environments that foster positive dating experiences for online daters.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process for registering and setting up an account in an online dating danger prevention system in some embodiments.

FIG. 2 conceptually illustrates a process for reducing or preventing online dating danger in some embodiments.

FIG. 3 is a continuation of the process in FIG. 2.

FIG. 4 conceptually illustrates a schematic diagram of an online dating danger prevention system in some embodiments.

FIG. 5 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel online dating danger prevention system that validates each online dater's profile in order to create a safe dating environment for online daters.

The online dating danger prevention system of some embodiments validates each online dater's profile by collecting data associated with the online dater. In some embodiments, the data associated with each online dater includes one or more of personal information, image data, location data, and document-based data. In some embodiments, the online dating danger prevention system stores the collected data in a database that is accessed from a computing device. In some embodiments, the online dating danger prevention system uses the collected and stored data to create safe dating environments that foster positive dating experiences for online daters.

In some embodiments, the online dating danger prevention system performs a set of processes for preventing or reducing danger for online daters. In some embodiments, the set of processes include a registration process and a dating danger prevention process. In some embodiments, the registration process and the dating danger prevention process are implemented as modules of a software application that runs on a computing device to allow the online dater to use the dating danger prevention system. In some embodiments, the software application is a mobile app that runs on a mobile computing device. In some embodiments, the mobile computing device is communicatively connected over a data communication network to one or more computing devices of the online dating danger prevention system which provide a dating danger prevention service to the mobile app running on the mobile computing device.

### I. Preventing or Reducing Online Dating Danger

In some embodiments, the online dating danger prevention system performs a set of processes for preventing or reducing danger for online daters. In some embodiments, the set of processes include a registration process and a dating danger prevention process. The registration process and dating danger prevention process include sets of steps which are summarized as follows.

1. User enters site

2. User registers

3. User provides verification for email

4. User installs software application on computing device

5. User creates a contact list for an event

6. User selects contacts to be notified for that event

7. User selects the time when the contacts should be notified if the user has not checked in to cancel activation

8. User takes a picture using image capture device of computing device (picture taken with online dater who is going on a date with the user using the device)

9. Application creates a time code (i.e., time stamp) and identifies geo-location, then attaches as meta-data to the picture, which is sent by the user to a secure server at an anonymous location, stored in a system database, and is never erased. The user's location is updated using GPS tracking

10. If user does not check in during allotted time, the server will alert the selected contacts in case of an emergency.

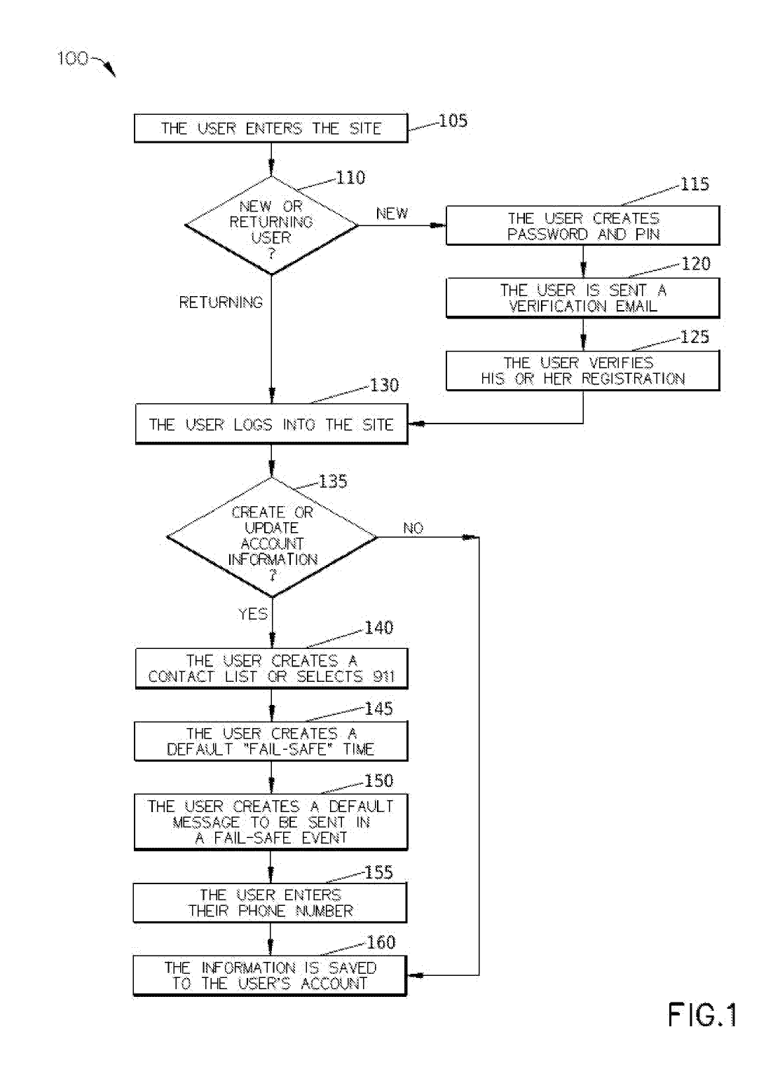

By way of example, FIG. 1 conceptually illustrates a process 100 for registering and setting up an account in an online dating danger prevention system in some embodiments. As shown in this figure, the process 100 includes a step (at 105) in which an online dater (i.e., “user”) enters the website for the online dating service. The online dater may be a new user seeking to generate a user profile with details to share with other online daters. Alternatively, the online dater may be returning to the website after previous registration and use of the online dating danger prevention system. Thus, the process 100 determines (at 110) whether the user is a new user or a returning user. If the online dater is a returning user, the process transitions to 130, which is described in further detail below.

On the other hand, if the online dater is a new user, the process 100 then allows the user to create (at 115) a password and PIN. Next, the process sends (at 120) a verification email to the user's specified email address. This step allows the system to link the new user profile to at least an email address because the user will have to verify the email by clicking a link in the verification email just sent out by the process. Thus, the process allows the user to verify (at 125) his or her online registration.

Once verified as a new user or determined to be a returning user, the process 100 allows the user to log into the website (at 130). The process authenticates the user, and then determines (at 135) whether an account needs to be created (for new users) or whether account information needs to be updated (for existing users). If no account needs to be created or updated, the process transitions to 160 to save the information to the user's account, which is described in greater detail below.

On the other hand, if the account needs to be created or updated, then the process 100 allows the user to create (at 140) a contact list of one or more numbers of people to contact in the event of an emergency. Thus, part of the registration process involves creating an initial contact list. This list may consist of individuals that the registered member would use as emergency contacts. However, the contact list can be updated, changed, replaced, or otherwise modified at any time by the registered user. In addition, the user may select 911 as the number to call in the event of an emergency.

Next, the process allows the user to create (at 145) a default “fail-safe” time. In some embodiments, the system uses a “fail safe” method to ensure that if an online dater does not “check in” after a specified amount of time during a date with another online dater, the system will treat the failure to “check in” as an emergency or danger and alert the contacts in the contact list. In addition, the process allows the user to create (at 150) a default message to be sent in the event that the fail-safe time is triggered. In some embodiments, the user is responsible for designating an amount of time they feel is needed before they need to check-in so that their emergency contacts will not be alerted. Also, the user is responsible for designating the message to send.

Next, the process allows the user to enter (at 155) his or her own phone number to complete the set of basic information for the online dating danger prevention system to collect and store. Finally, the process completes registration by saving (at 160) the information to a user account for the user in the data storage.

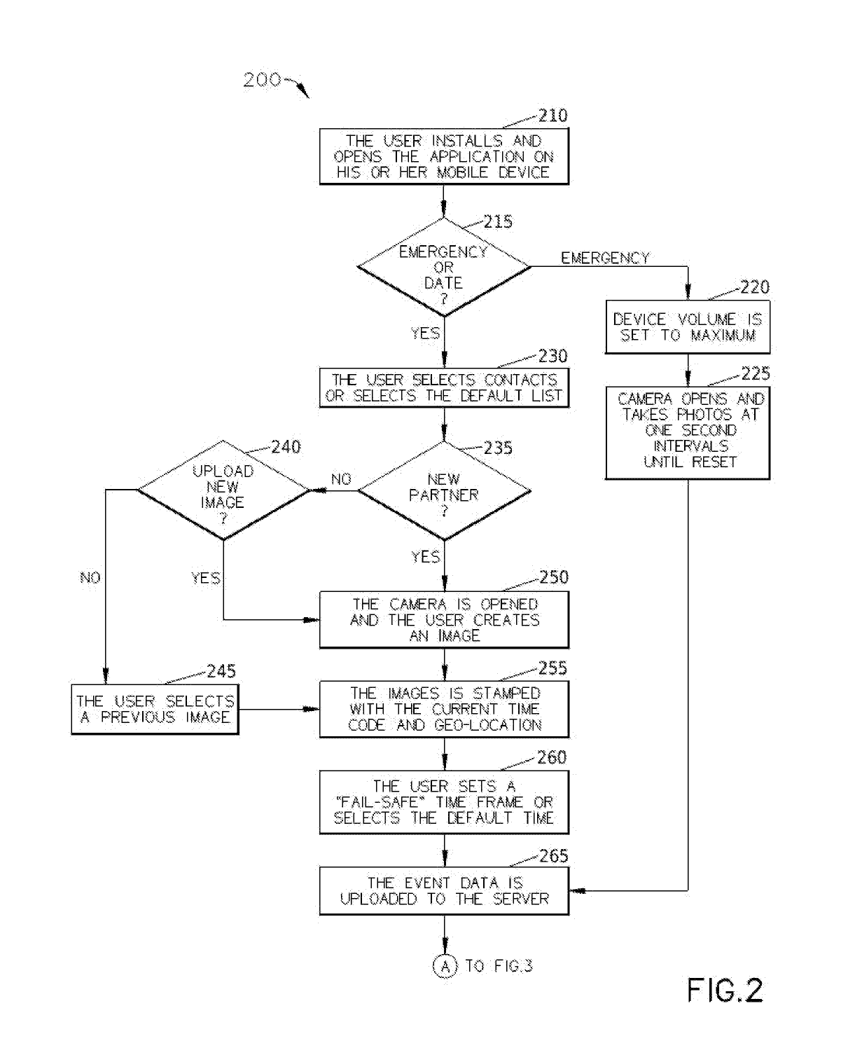

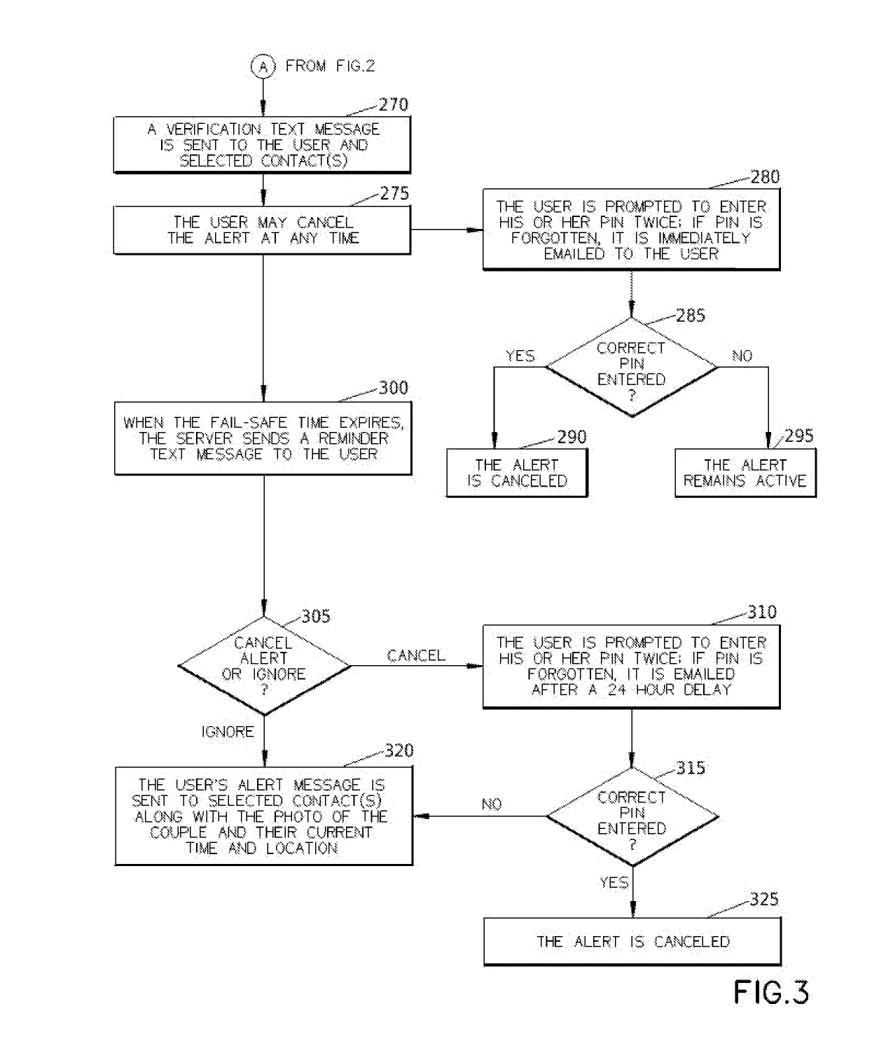

After a user is registered within the online dating danger prevention system, he or she may begin using the system to enhance the safety of his or her dating experiences. By way of example, FIGS. 2 and 3 conceptually illustrate a process 200 for reducing or preventing online dating danger in some embodiments. As shown in FIG. 2, the process 200 starts when the user installs and opens (at 210) the online dating danger prevention software application. The user may use a mobile computing/communication device to run this application, or any other computing device that connects to the data communication network to access the services of the online dating danger prevention system. Next, the process determines (at 215) whether there is an emergency or date situation. If there is an emergency, the process sets (at 220) the volume of the mobile computing device and the application to its maximum level. The process then opens (at 225) a image capture device on the mobile computing device and launches any software for operating and controlling the image capture device, thereby allowing the process 200 to take a series of photos by capturing an image at set intervals until a specified time is exceeded. For example, the image capture device may be controlled by the process 200 to capture an image every second until a reset command is received to reset the emergency alert within the software application. After that, the process 200 transitions to 265 to upload event data, which is described further below.

If the process 200 determines (at 215) that a date situation is underway, then the process allows the user (at 230) to select contacts or select a default list in relation to a date. The process then determines (at 235) whether the selected contact is a new partner. The process 200 employs a logic tree to determine outcome when going on another date with a previous date. If on a second/third date, etc., a user has the option of using the same photo previously taken or selecting if they are on a date with a different person. If meeting someone again for a second or third date, the user must select last image. If they are with a new date they must select new image. In some embodiments, the logic tree can be adapted to require new pictures all the time, or may allow previously used pictures to be used only for a certain amount of time, regardless of whether or not there have been multiple prior dates between the same online daters.

In any event, if a new partner was selected, the process transitions to 250, which is described below. However, if the selection was not a new partner, then the process determines (at 240) whether the user will upload a new image. If the user does not upload a new image, the process allows the user (at 245) to select a previous image. On the other hand, if a new image is uploaded, the process activates (at 250) the image capture device of the mobile computing device to allow the user to capture an image to use as a new photo of him or her self with the dating partner. Next, the process adds meta-data to the image (at 255). In some embodiments, the process time stamps the image (i.e., either the newly captured image or the selected previous image). In some embodiments, the process time stamps the image with the current time. In some embodiments, the process also stamps the image with geo-location information related to where the image was captured or selected. In some embodiments, each of the time stamp and the geo-location information is stored in meta-data of a image file that includes the selected or captured image. Thus, the process 200 ensures that while a registered user is on a date, the physical appearance of the other person will be ascertained through the captured image. This picture is then saved in a data storage device (e.g., database) accessible to an anonymous and secure server. This server acts as a security box documenting time, location and an image of the person and their date.

Next, the process 200 allows the user (at 260) to a set a “fail safe” time frame for the date or select the default fail safe time which the user set during registration, as described by reference to FIG. 1, above. After this, the process 200 uploads the event data (i.e., the event being related to either the emergency situation or the date situation, as determined by the process 200 at step 215, described above) to the server computing device in the online dating danger prevention system which provides the online dating danger prevention service accessed by the software application running on the user's mobile computing device.

Next, as shown in FIG. 3, the process 200 sends (at 270) a verification message to the user and one or more selected contacts. This situation is dependent upon an alert being triggered either by the user consciously activating the alert or by the default time being triggered. The user can cancel the alert at any time so that the process will immediately stop (at 275) contacting the user and contacts, and any audible alerts that have been sounding an alert. In some embodiments, the process 200 prompts (at 280) the user to input a PIN to deactivate the alert. In some embodiments, the process requires the user to input the PIN twice. However, if the user has forgotten the PIN, the process 200 immediately sends (at 280) the PIN to the email address specified at the time of registration. Next, the process 200 determines (at 285) whether the input PIN is correct. If the PIN was input correctly by the user, the process cancels (at 290) the alert. If not, then the process 200 does not deactivate the alert, instead keeping (at 295) the alert active.

In some embodiments, when the fail-safe time expires, the process (at 300) sends a reminder text message to the user. The process 200 then determines (at 305) whether to cancel the alert or not. If ignored, the process transitions to 320, which is described below. However, for cancellation, the process 200 first prompts (at 310) the user to enter the PIN twice, sending an email if forgotten. The process next determines (at 315) whether the correct PIN was entered by the user. If the correct PIN was not entered, the process sends (at 320) the user's alert message to the specified contact or contacts, along with the photo of the couple with the included time stamp and location meta-data. On the other hand, if the correct PIN was entered, the process cancels (at 325) the alert.

In this way, the online dating danger prevention system and processes encourage positive dating experiences as opposed to the negative dating dangers that could arise or be present when dating. In addition, the online dating danger prevention system and processes uses a variety of data types to foster positive experiences that create safe dating situations for online daters. In some embodiments, the online dating danger prevention system includes a computing device in which the process stores the collected data (i.e., information and documents) like a security box. Thus, the event data that is uploaded to the system is not deleted or removed.

As stated above, the online dating danger prevention system and processes encourage positive dating situations by helping to reduce or prevent dating dangers which an online dater may encounter. By ensuring that the identity of a partner on a date can be easily discoverable, the system allows the appropriate contacts—friends, family, authorities, etc.—to be alerted when dangers arise. Furthermore, including time stamp and location meta data with image data, and storing this data in a database, the system can access the database to include the data in any alert that is triggered during a date. Also, in some embodiments, the system can provide the most up-to-date location data because the location data in some embodiments is updated at set intervals (e.g., every ten minutes, etc.) along with location information. The online dating danger prevention system is further detailed in the next section.

### II. Online Dating Danger Prevention System

Many of the above described features are available to online daters by way of a software application or program that runs on a computing device of online daters (i.e., a computing device “user”). When the software is downloaded, installed, and running on a user's computing device, the online dating danger prevention system allows users to reduce dangers associated with online dating. Users can leverage the benefits of the online dating danger prevention system regardless of the dating service being used to search for potential people to date. In particular, many users may feel wary about meeting a person whose only known qualities and characteristics are based solely on information provided by that person, and therefore, is a mystery. While such a person may be a potential date, to many users, the uncertainty of identity, intentions, and other matters makes the person a potential danger, as well. However, the online dating danger prevention system offers services that can reduce the dangers associated with online dating.

The online dating danger prevention system of some embodiments validates each online dater's profile by collecting data associated with the online dater. In some embodiments, the data associated with each online dater includes one or more of personal information, image data, location data, and document-based data. In some embodiments, the online dating danger prevention system stores the collected data in a database that is accessed from a computing device. In some embodiments, the online dating danger prevention system uses the collected and stored data to create safe dating environments that foster positive dating experiences for online daters.

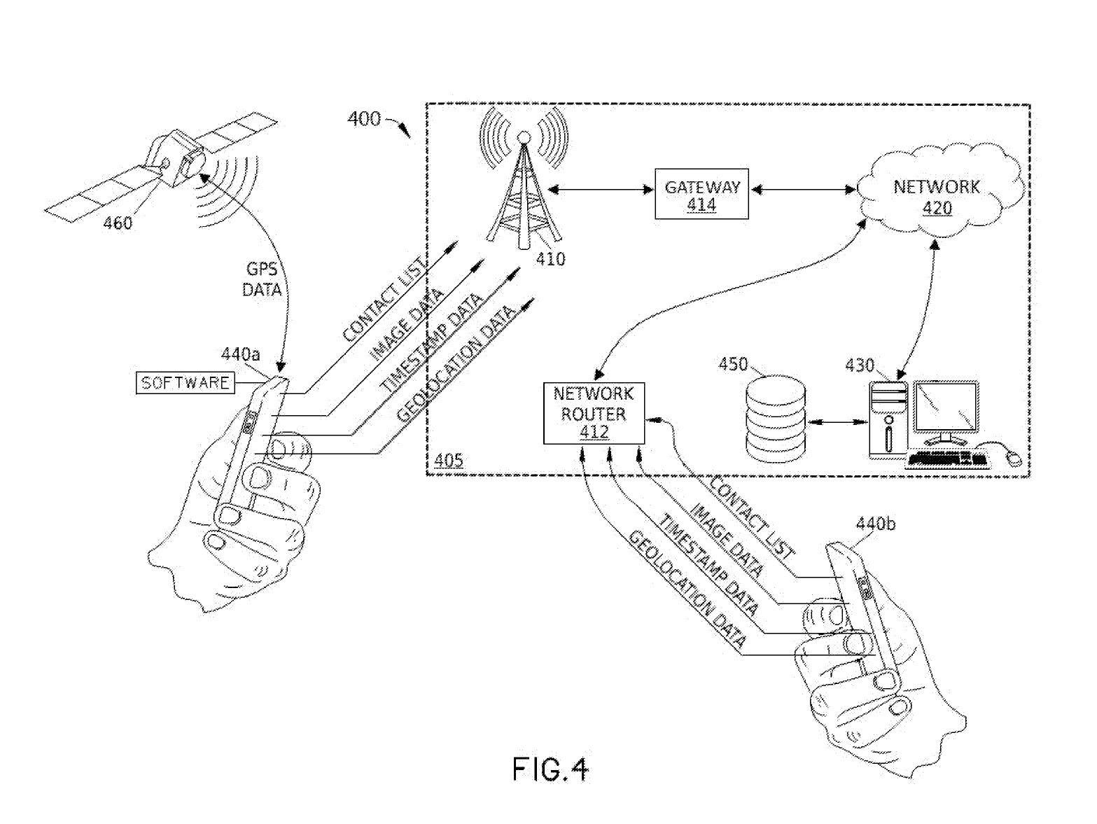

By way of example, FIG. 4 conceptually illustrates a schematic diagram of an online dating danger prevention system 400 in some embodiments. As shown in this figure, the online dating danger prevention system 400 includes a service environment 405 comprising a plurality of system resources to facilitate processing operations of the online dating danger prevention system contemporaneously with online daters accessing the system. Within the service environment 405 is a server computing device 430 that provides online dating danger prevention services to user computing devices 440a and 440b. Various embodiments of computing devices (e.g., user computing devices 440a and 440b) are implemented on different portable multifunction device types. Devices 440a and 440b can be any portable electronic or computing device capable of communicating with the online dating danger prevention system. For example, user devices 440a and 440b may be mobile communication computing devices (i.e., smart phones) that include processing units for running mobile software applications or programs for obtaining safety services of the online dating danger prevention system. Examples of mobile operating system platforms that may support the kernels and device drivers of user computing devices 440a and 440b include iOS and Android. Custom software applications would then operate on top of the iOS and/or Android operating system layer.

User computing devices 440a and 440b access the online dating danger prevention services through various communication methods and protocols. In some embodiments, user computing devices 440a and 440b communicate over one or more wired or wireless networks 410 and/or 412. For example, wireless network 410, such as a cellular network, can communicate with a wide area network (WAN) 420, such as the Internet, by use of a gateway 414. The gateway 414 in some embodiments provides a packet oriented mobile data service, such as General Packet Radio Service (GPRS), or other mobile data service allowing wireless networks, such as wireless network 410, to transmit data to other networks, such as wide area network 420 (i.e., the Internet). Likewise, network router 412 is a network access device that (e.g., IEEE 802.11g wireless access device) provides communication access from a computing device, such as user computing device 440b, to wide area network 420.

In various embodiments, any of the illustrated mobile computing devices 440a and 440b may simultaneously communicate with the online dating danger prevention system 400 by way of wide area network 420. In some embodiments, a connection to the server computing device 430 is established so that an online dater can upload one or more contacts in a contact list, image data captured while on a date, as well as time stamp and geo-location data that is added to each image as meta-data. In order to ensure the safety of the online dater, the user's mobile computing device may use a persistent connection to the server computing device 430. In some embodiments, the persistent connection is established as a secure connection to the server 430 in accordance with one or more security protocols, such as the Secure Sockets Layer (SSL) protocol or the Transport Layer Security (TLS) protocol. User computing devices 440a and 440b can also establish communication by other means.

User computing devices 440a and 440b may also receive Global Positioning Satellite (GPS) signals from one or more GPS satellites 460. The online dating danger prevention system of some embodiments obtains geolocation data of an online user when the user mobile computing device 440a receives updated location data from the GPS satellite. In some embodiments, the software running on the user's mobile computing device 440a requests location data from the GPS satellites 460 at set time intervals while a date is in progress. The user's mobile computing device 440a then transmits the updated location data to the server computing device 430 for storage in the secure data storage device 450. As noted above, all information and data related to an event is stored in a database of the data storage device 450. The data is persistent and is not removed or deleted after the event is finished. In some embodiments, the geolocation data that is included as meta-data embedded in the image is also stored as a separate data item in the data storage device 450. Thus, the online dating danger prevention system is able to retain highly accurate location data of any online dater with an event unfolding. In some embodiments, the user is responsible for logging into the service after the date is completed in order to avoid the Fail-Safe alert, which will notify emergency contact list.

Therefore, when it comes to online dating, with so much anonymity and so many dangers lurking, people need assurances of identities, intentions, and other matters related to potential dates. The online dating danger prevention system described by reference to FIG. 4 provides such security to online daters by way of a site that securely stores information about who a person is with, where the person is approximately located, and what time the person was at particular locations. In this way, the online dating danger prevention system facilitates a safer and more enjoyable dating experience that can lead to a better chance at future relationships. While embodiments of the invention described by reference to FIGS. 1-4, above, have included online dating danger prevention processes and systems, a person having ordinary skill in the relevant art would understand that the system could be adapted for use by parents ensuring the safety of their children, or by individuals to create increased personal safety.

### III. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

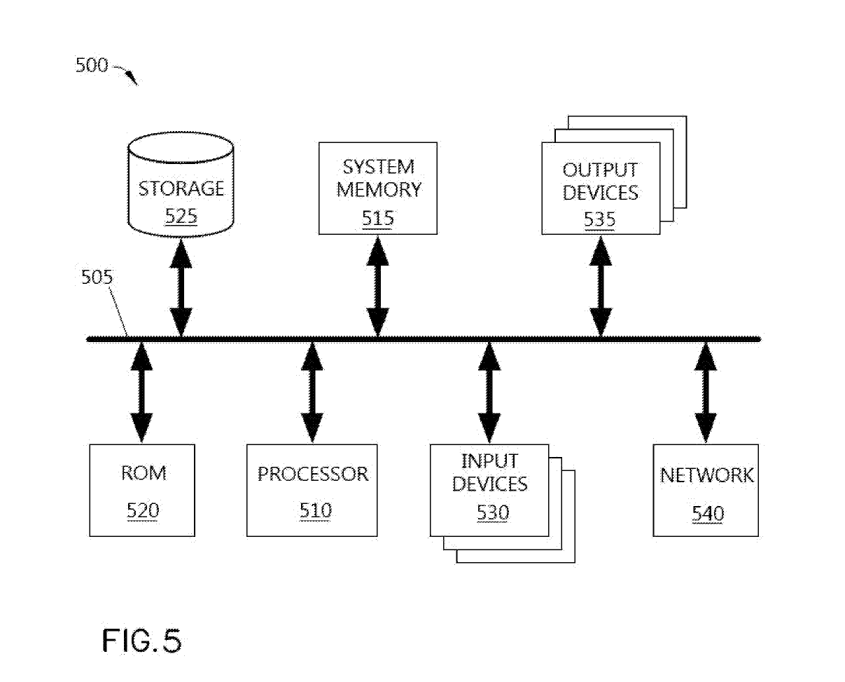

FIG. 5 conceptually illustrates an electronic system 500 with which some embodiments of the invention are implemented. The electronic system 500 may be a computer, phone, PDA, or any other sort of electronic device. Such an electronic system includes various types of computer readable media and interfaces for various other types of computer readable media. Electronic system 500 includes a bus 505, processing unit(s) 510, a system memory 515, a read-only 520, a permanent storage device 525, input devices 530, output devices 535, and a network 540.

The bus 505 collectively represents all system, peripheral, and chipset buses that communicatively connect the numerous internal devices of the electronic system 500. For instance, the bus 505 communicatively connects the processing unit(s) 510 with the read-only 520, the system memory 515, and the permanent storage device 525.

From these various memory units, the processing unit(s) 510 retrieves instructions to execute and data to process in order to execute the processes of the invention. The processing unit(s) may be a single processor or a multi-core processor in different embodiments.

The read-only-memory (ROM) 520 stores static data and instructions that are needed by the processing unit(s) 510 and other modules of the electronic system. The permanent storage device 525, on the other hand, is a read-and-write memory device. This device is a non-volatile memory unit that stores instructions and data even when the electronic system 500 is off. Some embodiments of the invention use a mass-storage device (such as a magnetic or optical disk and its corresponding disk drive) as the permanent storage device 525.

Other embodiments use a removable storage device (such as a floppy disk or a flash drive) as the permanent storage device 525. Like the permanent storage device 525, the system memory 515 is a read-and-write memory device. However, unlike storage device 525, the system memory 515 is a volatile read-and-write memory, such as a random access memory. The system memory 515 stores some of the instructions and data that the processor needs at runtime. In some embodiments, the invention's processes are stored in the system memory 515, the permanent storage device 525, and/or the read-only 520. For example, the various memory units include instructions for processing appearance alterations of displayable characters in accordance with some embodiments. From these various memory units, the processing unit(s) 510 retrieves instructions to execute and data to process in order to execute the processes of some embodiments.

The bus 505 also connects to the input and output devices 530 and 535. The input devices enable the user to communicate information and select commands to the electronic system.

The input devices 530 include alphanumeric keyboards and pointing devices (also called “cursor control devices”). The output devices 535 display images generated by the electronic system 500. The output devices 535 include printers and display devices, such as cathode ray tubes (CRT) or liquid crystal displays (LCD). Some embodiments include devices such as a touchscreen that functions as both input and output devices.

Finally, as shown in FIG. 5, bus 505 also couples electronic system 500 to a network 540 through a network adapter (not shown). In this manner, the computer can be a part of a network of computers (such as a local area network (“LAN”), a wide area network (“WAN”), or an intranet), or a network of networks (such as the Internet). Any or all components of electronic system 500 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-3 conceptually illustrate processes in which the specific operations of these processes may not be performed in the exact order shown and described. Specific operations may not be performed in one continuous series of operations, and different specific operations may be performed in different embodiments. Furthermore, the processes could be implemented using several sub-processes, or as part of a larger macro process. Thus, one of ordinary skill in the art would understand that the invention is not to be limited by the foregoing illustrative details, but rather is to be defined by the appended claims.

I claim:

1. An online dating danger prevention system that is used to facilitate a safe dating environment between online daters meeting for a date at a real-world location, said online dating danger prevention system comprising:
a secure server computer that is connected to a network and runs a web server software application to host a site accessible to a first person going on a date with a second person, wherein said site allows (i) the first person, before the date, to provide a set of contacts to reach in the event of an emergency in connection with the date and (ii) the first person to provide a photograph during the date at the real-world location with the second person;
a database management system comprising the database and a database management application connected to the web server and interfaced by a secure process running on a processing unit of the secure web server computer, wherein said database management system stores the set of contacts and the photograph in the database when the secure process receives the set of contacts and the photograph from the secure server; and
a mobile computing device that is connected to the network and runs a software application that allows the first person to access services provided by the web server software application.

2. The online dating danger prevention system of claim 1, wherein the web server software application comprises an online dating danger prevention service which the mobile computing device of the first person accesses.

3. The online dating danger prevention system of claim 1, wherein the mobile computing device of the first person comprises an image capture device.

4. The online dating danger prevention system of claim 3, wherein said photograph is an image captured by the image capture device of the first person's mobile computing device.

5. The digital multimedia data storage system of claim 4, wherein the mobile computing device comprises a GPS transceiver for sending location requests to one or more GPS satellites and receiving location data from the one or more GPS satellites.

6. The online dating danger prevention system of claim 5, wherein the received location data is added to an embedded meta-data storage location of the captured image.

7. The online dating danger prevention system of claim 6, wherein time stamp data is added to a second embedded meta-data storage location of the captured image based on a time during which the image was captured.

8. A non-transitory computer readable medium storing a program which when executed by at least one processing unit of a computing device prevents or reduces online dating danger, said program comprising sets of instructions for:
receiving a set of contacts associated with a first online dating person;
storing the set of contacts in a database;
receiving a fail-safe timed duration after which an alert is transmitted to the set of contacts if the first online dating person has not checked-in during the fail-safe timed duration;
storing the fail-safe timed duration in the database;
receiving an image of the first online dating person and a second online dating person captured at a real-world location by an image capture device that includes a set of meta-data along with the image, said set of meta-data comprising time stamp data that corresponds to a time the image was captured and location data that corresponds to the real-world location;
storing the received image, the time stamp data, and the location data in the database;
organizing the database so that the stored set of contacts, the stored image, and stored time stamp data, and the stored location data are grouped in a persistent data structure associated with the first online dating person; and
linking a set of known information about the second online dating person to the persistent data structure associated with the first online dating person, said second online dating person dating the first online dating person at the real-world location.

9. The non-transitory computer readable medium of claim 8, wherein the program further comprises a set of instructions for receiving a check-in from the first online dating person during the fail-safe timed duration.

10. The non-transitory computer readable medium of claim 9, wherein said received check-in from the first online dating person during the fail-safe timed duration resets the check-in time of the fail-safe timed duration.
